(19) United States
(12) Patent Application Publication
(10) Pub. No.: US 2023/0246559 A1
(43) Pub. Date: Aug. 3, 2023

(54) FILTER CONNECTED TO PWM CONVERTER AND CONVERTER SYSTEM

(71) Applicant: FANUC CORPORATION, Yamanashi (JP)

(72) Inventor: Yuuya NAKAGAWA, Yamanashi (JP)

(21) Appl. No.: 18/003,500

(22) PCT Filed: Aug. 18, 2021
(86) PCT No.: PCT/JP2021/030225

§ 371 Date: Dec. 28, 2022

(30) Foreign Application Priority Data
Aug. 24, 2020 (JP) 2020-141026

(51) Int. Cl. H02M 5/42; H02M 1/08

(52) U.S. Cl. CPC H02M 5/42; H02M 1/08

(57) ABSTRACT

This filter is provided at an AC input/output side of a PWM converter in which a smoothing capacitor and a preliminary charging circuit for preliminary-charging the smoothing capacitor are connected, the filter comprising: a reactor connected in series to the PWM converter; a filter capacitor connected in parallel to the PWM converter; and a switch which electrically connects the reactor to the filter capacitor in a closed state and electrically disconnects the reactor from the filter capacitor in an open state. When power is to be applied to the PWM converter, the switch is in the open state.

### TECHNICAL FIELD

The present invention relates to a filter connected to a PWM converter and a converter system.

### BACKGROUND ART

In a motor drive unit configured to control driving of a motor in machine tools, forming machinery, injection molding machines, industrial machinery, or various types of robots, AC power supplied from an AC power supply is converted temporarily into DC power by a converter (rectifier); subsequently, the DC power is further converted into AC power by an inverter, and the AC power is supplied to the motor as motor driving power.

As a converter in a motor drive unit, a PWM converter is widely employed, the PWM converter being capable of power regeneration that can return regenerative power generated during decelerating a motor to a three-phase AC power supply. Such a PWM converter includes a bridge circuit constructed from a power device consisting of a diode and a switching device connected in antiparallel with the diode. With on-off operations of the switching devices being controlled in accordance with a PWM control method, the PWM converter can perform bi-directional power conversion between AC power on the AC input/output side and DC power on the DC input/output side.

The PWM converter includes a smoothing capacitor on the DC input/output side. The smoothing capacitor has a function of suppressing a pulsating component of a DC output from the PWM converter as well as a function of storing DC power.

The smoothing capacitor needs to be charged to a predetermined voltage after the motor drive unit is powered on (i.e., after the PWM converter is powered on) and before the motor is driven (i.e., before the power conversion is performed by the inverter). This charging is commonly referred to as precharging (initial charging). A precharge circuit configured to precharge the smoothing capacitor is provided between a main power converter circuit and the smoothing capacitor in the PWM converter or on the AC input/output side of the main power converter circuit in the PWM converter. The precharge circuit is a circuit for limiting inrush current flowing into the smoothing capacitor at power-on to protect a power device from overcurrent, and the circuit may be referred to as “initial charging circuit” or “inrush current-limiting circuit.”

By turning on/off the switching devices in the PWM converter, high-frequency ripple current is generated on the AC input/output side of the PWM converter. To reduce this high-frequency ripple current, it is common to provide, on the AC input/output side of the PWM converter, an LC filter (which may be simply referred to as “filter” hereinafter), which is constructed from a reactor and a capacitor.

For example, in matrix converters that include an LC filter provided on the input side of a three-phase AC power supply and a snubber circuit including a first group of snubber diodes for full-wave rectification of a three-phase input power supply, a second group of snubber diodes for full-wave rectification of a three-phase output power supply, and a snubber capacitor connected to DC voltage rectified by said first and second groups of snubber diodes and that connect each phase of said three-phase AC power supply directly with the corresponding phase of said three-phase output power supply with a bi-directional switch, the matrix converter being configured to output any given AC/DC voltage by performing a PWM control on the voltage from the AC power supply in accordance with an output voltage command, there is known a matrix converter characterized in that the matrix converter includes: a snubber inrush current-limiting circuit that is placed between said first group of snubber diodes and said snubber capacitor and that includes a current-limiting resistor for limiting charging current to said snubber capacitor and a short-circuit contactor for short-circuiting both ends of the current-limiting resistor; means for detecting the voltage across both ends of said snubber capacitor and short-circuiting said short-circuit contactor when the detected voltage is equal to or higher than a certain level of voltage; and an input filter resonance suppressive capacitor for limiting resonance voltage of said LC filter within a predetermined voltage range, the capacitor being placed between said first group of snubber diodes and said current-limiting resistor (see, e.g., PTL 1).

### CITATION LIST

### Patent Literature

[PTL 1] Japanese Patent No. 4662022

### SUMMARY OF INVENTION

### Technical Problem

When a filter and a PWM converter are powered on, precharging of a smoothing capacitor 3 is started. As the precharging is started in a condition where no energy is stored in the smoothing capacitor, immediately after the PWM converter is powered on, the current flowing into the smoothing capacitor will be limited by the precharge circuit. Consequently, the smoothing capacitor cannot suppress fluctuation of voltage applied to the power device until the precharging is complete. At power-on, LC resonance will be generated between a filtering capacitor and the reactor in the filter, which causes a voltage higher than usual at the AC input side of the PWM converter. When LC resonance is generated and a voltage exceeding the rated voltage is applied to the power device in the PWM converter, it may cause the power device to be broken. Therefore, it is desired to provide, for PWM converters on the AC input/output side of which a filter is provided, a technique for preventing breakage of a power device caused by LC resonance generated at power-on.

### Solution to Problem

According to an aspect of the present disclosure, a filter to be provided on the AC input/output side of a PWM converter in which a smoothing capacitor and a precharge circuit configured to precharge the smoothing capacitor are connected includes: a reactor to be connected in series with the PWM converter; a filtering capacitor to be connected in parallel with the PWM converter; and a switch configured to electrically connect the reactor with the filtering capacitor in a closed state and electrically disconnect the reactor from the filtering capacitor in an open state, and the switch is in the open state when the PWM converter is powered on.

According to an aspect of the present disclosure, the converter system includes: a PWM converter including a power conversion unit configured to perform power conversion between AC power on the AC input/output side and DC power on the DC input/output side by means of a PWM control, a capacitor provided on the DC input/output side of the power conversion unit, and a precharge circuit configured to precharge a smoothing capacitor; and a filter including a reactor to be connected in series with the power conversion unit on the AC input/output side, a filtering capacitor to be connected in parallel with the power conversion unit on the AC input/output side, and a switch that electrically connects the reactor with the filtering capacitor in a closed state and that electrically disconnects the reactor from the filtering capacitor in an open state, and the switch is in the open state when the PWM converter is powered on.

### Advantageous Effects of Invention

According to an aspect of the present disclosure, a PWM converter, on the AC input/output side of which a filter is provided, can prevent breakage of a power device caused by LC resonance generated at power-on.

### BRIEF DESCRIPTION OF DRAWINGS

FIG. 1 is a diagram illustrating a filter including a switch controller unit and a converter system according to an embodiment of the present disclosure;

FIG. 2 is a diagram illustrating a filter and a converter system including a switch controller unit according to an embodiment of the present disclosure;

FIG. 3 is a diagram illustrating a first connection configuration of a filter according to an embodiment of the present disclosure;

FIG. 4 is a diagram illustrating a second connection configuration of a filter according to an embodiment of the present disclosure;

FIG. 5 is a diagram illustrating a third connection configuration of a filter according to an embodiment of the present disclosure;

FIG. 6 is a diagram illustrating a fourth connection configuration of a filter according to an embodiment of the present disclosure;

FIG. 7 is a flowchart illustrating a first operation mode of a filter, and a switch and a precharge circuit in a PWM converter according to an embodiment of the present disclosure;

FIG. 8 is a flowchart illustrating a second operation mode of a filter, and a switch and a precharge circuit in the PWM converter according to an embodiment of the present disclosure;

FIG. 9A is a diagram illustrating a flow of current in a sequence of operations of a filter, and a switch and a precharge circuit in a PWM converter according to an embodiment of the present disclosure, and illustrates the flow of current during a precharging period;

FIG. 9B is a diagram illustrating a flow of current in a sequence of operations of a filter, and a switch and a precharge circuit in a PWM converter according to an embodiment of the present disclosure, and illustrates the flow of current after the precharging is complete; and

FIG. 10 is a diagram illustrating a filter including a switch controller unit and a converter system according to a variation of an embodiment of the present disclosure.

### DESCRIPTION OF EMBODIMENTS

With reference to the drawings, a filter connected to a PWM converter and a converter system will be described below. In each drawing, similar members are denoted by similar reference numerals. To facilitate understanding, these drawings use different scales as appropriate. An embodiment illustrated in the drawing is an example for implementing the present disclosure, and the present disclosure is not limited to the illustrated embodiment.

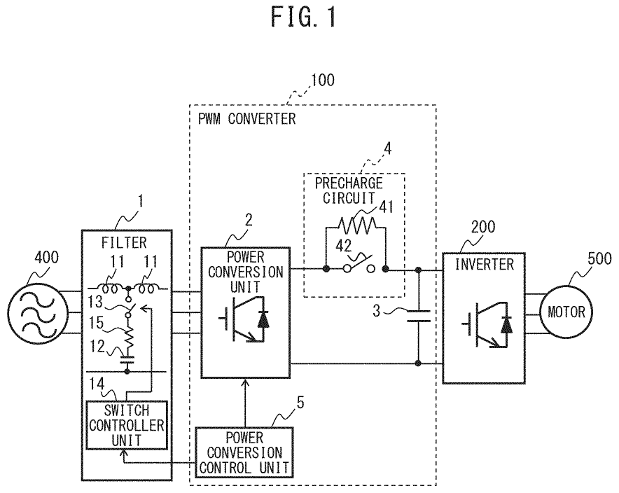

FIG. 1 is a diagram illustrating a filter including a switch controller unit and a converter system according to an embodiment of the present disclosure.

As an example, a case where a motor 500 is controlled by a motor drive unit connected to an AC power supply 400 is illustrated. In the present embodiment, a type of the motor 500 is not particularly limited, and it may be an induction motor or a synchronous motor. The numbers of phases of the AC power supply 400 and the motor 500 do not particularly limit the present embodiment, and the numbers of phases may be, for example, three phases or a single phase. In an example illustrated in FIG. 1, both of the AC power supply 400 and the motor 500 are three-phase. Examples of the AC power supply 400 include a three-phase 400 V AC power supply, a three-phase 200 V AC power supply, a three-phase 600 V AC power supply, and a single-phase 100 V AC power supply. Examples of machinery provided with the motor 500 include, for example, a machine tool, a robot, forming machinery, an injection molding machine, and an industrial machine.

As illustrated in FIG. 1, the motor drive unit according to an embodiment of the present disclosure includes a filter 1, a PWM converter 100, and an inverter 200.

The PWM converter 100 is configured as a rectifier capable of power regeneration by means of a PWM control, which can perform bi-directional power conversion between AC power on the AC input/output side and DC power on the DC input/output side. The PWM converter 100 includes a power conversion unit 2, a smoothing capacitor 3, a precharge circuit 4, and a power conversion control unit 5. In the following description, “power-on of the PWM converter 100” means “starting supply of power from the AC power supply 400 to the power conversion unit 2 of the PWM converter 100.” In other words, before power-on of the PWM converter 100, power is not supplied from the AC power supply 400 to the power conversion unit 2; after power-on of the PWM converter 100, power is supplied from the AC power supply 400 to the power conversion unit 2. Note that, although it is not illustrated herein, a power line for supplying power to the power conversion control unit 5 is different from that for supplying power from the AC power supply 400 to the power conversion unit 2. In other words, even before power-on of the power conversion unit 2 of the PWM converter 100, power for activating the power conversion control unit 5 is supplied in preparation for operating the power conversion control unit 5 at power-on of the power conversion unit 2 of the PWM converter 100.

The power conversion unit 2 of the PWM converter 100, which serves as a main power converter circuit, includes a full-bridge circuit constructed from a power device consisting of a diode and a switching device connected in antiparallel with the diode. Examples of switching devices include an IGBT, an FET, a thyristor, a GTO, and a transistor, although other types of semiconductor devices may be used. In the example illustrated in FIG. 1, since the AC power supply 400 is assumed to be a three-phase AC power supply, the power conversion unit 2 is constructed from a three-phase full-bridge circuit. When single-phase AC power is supplied from the AC power supply 400, the power conversion unit 2 is constructed from a single-phase bridge circuit. The power conversion unit 2 selectively performs, as the power conversion control unit 5 controls on-off operations of the switching devices in accordance with a PWM control method, a rectifying operation that converts AC power input from the AC input/output side into DC power and outputs the DC power to the DC input/output side and a regenerative operation that converts DC power on the DC input/output side into AC power and outputs the AC power to the AC input/output side.

The smoothing capacitor 3 is provided on the DC input/output side of the power conversion unit 2. The smoothing capacitor 3 has a function of suppressing a pulsating component of a DC output from the power conversion unit 2 as well as a function of storing DC power. The smoothing capacitor 3 may be referred to as a DC link capacitor. Examples of the smoothing capacitor 3 include, for example, an electrolytic capacitor and a film capacitor.

In the example illustrated in FIG. 1, between the power conversion unit 2 and the smoothing capacitor 3, the precharge circuit 4 configured to precharge the smoothing capacitor 3 is provided. Instead, the precharge circuit 4 may be provided on the AC input/output side of the power conversion unit 2.

The precharge circuit 4 includes a precharge resistor 41 and a precharge switch 42 connected in parallel with the precharge resistor 41. The precharge switch 42 can be selectively switched between an open state in which an electric path that goes through the precharge resistor 41 is formed and a closed state in which a short circuit that does not go through the precharge resistor 41 is formed. Although illustration of a control unit configured to control open/close operations of the precharge switch 42 is omitted, the control unit may be provided in the power conversion control unit 5. During the precharging period after power-on of the PWM converter 100 until driving of the motor 500 is started, direct current output from the power conversion unit 2 will flow into the smoothing capacitor 3 through the precharge resistor 41 by setting the precharge switch 42 to the open state, which causes the smoothing capacitor 3 to be charged. During the precharging period, the direct current output from the power conversion unit 2 flows through the precharge resistor 41, and generation of inrush current can be prevented. When the smoothing capacitor 3 is charged to a predetermined voltage, the precharge switch 42 is switched from the open state to the closed state, and precharging is completed. Note that illustration of a detection unit configured to detect the voltage across the smoothing capacitor 3 is omitted.

To the DC input/output side of the PWM converter 100, the inverter 200 is connected. The circuit portion that electrically connects the DC input/output side of the PWM converter 100 with the DC input/output side of the inverter 200 is referred to as a “DC link.” The DC link may be referred to as a “DC link unit”, a “direct current link”, a “direct current unit”, a “DC bus line”, a “DC intermediate circuit”, or the like.

The inverter 200 is constructed from a full-bridge circuit including a switching device and a diode connected in antiparallel with the switching device. Examples of switching devices include an IGBT, an FET, a thyristor, a GTO, and a transistor, although other types of semiconductor devices may be used. In the example illustrated in FIG. 1, since the motor 500 is assumed to be a three-phase AC motor, the inverter 200 is constructed from a three-phase full-bridge circuit. When the motor 500 is a single-phase AC motor, the inverter 200 is constructed from a single-phase bridge circuit.

The inverter 200 converts DC power at the DC link into AC power as a result of the on-off operations of the switching devices in the inverter 200 being controlled by means of a PWM control according to a command from a higher-level controller (not illustrated), and supplies the AC power to the motor 500 provided on the AC input/output side of the inverter 200; in addition, the inverter 200 converts the AC power regenerated by deceleration of the motor 500 into DC power and returns the DC power to the DC link. The motor 500 is controlled based on the AC power supplied from the inverter 200 with respect to the speed, the torque, or the position of the rotor. The higher-level controller that controls the inverter 200 may be constructed from a combination of an analog circuit and an arithmetic processing device, or may be constructed from an arithmetic processing device only. The arithmetic processing devices that may constitute the higher-level controller that controls the inverter 200 include an IC, an LSI, a CPU, an MPU, and a DSP.

To the AC input/output side of the PWM converter 100, the filter 1 is provided.

The filter 1 includes: a reactor 11 to be connected in series with the PWM converter 100; a filtering capacitor 12 to be connected in parallel with the PWM converter; and a switch 13 that electrically connects the reactor 11 with the filtering capacitor 12 in a closed state and that electrically disconnects the reactor 11 from the filtering capacitor 12 in an open state. In addition, in the example illustrated in FIG. 1, a switch controller unit 14 configured to control open/close operations of the switch 13 is provided in the filter 1. Turning on/off the filter 1 and the switching devices in the PWM converter when the switch 13 is in the closed state will exhibit a function of reducing high-frequency ripple current generated on the AC input/output side of the PWM converter. While details of the operations of the switch controller unit 14 will be described later, in an embodiment of the present disclosure, the switch controller unit 14 control the switch 13 in such a way that the switch 13 is kept in the open state at power-on of the PWM converter, i.e., upon starting precharging operation by the precharge circuit 4. Note that, although it is not illustrated herein, a power line for supplying power to the switch controller unit 14 is different from that for supplying power from the AC power supply 400 to the power conversion unit 2. In other words, even before power-on of the power conversion unit 2 of the PWM converter 100, power for activating the switch controller unit 14 is supplied in preparation for operating the switch controller unit 14 at power-on of the power conversion unit 2 of the PWM converter 100.

Examples of the filtering capacitor 12 include, for example, an electrolytic capacitor and a film capacitor. Examples of the switch 13 include a relay, a semiconductor switching device and an electromagnetic contactor. Examples of semiconductor switching devices include an FET, an IGBT, a thyristor, a GTO, and a transistor.

Note that, in FIG. 1, in order to make the drawing simple and clear, a configuration of connections between the reactor 11, the filtering capacitor 12, and the switch 13 in the filter 1 is illustrated schematically. Specific configurations of connections between the reactor 11, the filtering capacitor 12, and the switch 13 in the filter 1 will be described later.

In the example illustrated in FIG. 1, since the AC power supply 400 is assumed to be a three-phase AC power supply, a three-phase power line electrically connects the AC power supply 400 with the power conversion unit 2 constructed from a three-phase full-bridge circuit. In this case, each of the lines for two phases of the three-phase power line is provided with a first filter, which is the filter 1 including the reactor 11, the filtering capacitor 12 and the switch 13; in other words, two filters 1 are provided. The line for the remaining one phase of the power line is provided with a second filter that is constructed by removing the switch 13 from the filter 1. Note that when the AC power supply 400 is a single-phase AC power supply, the single-phase power line that electrically connects the AC power supply 400 with the power conversion unit 2 constructed from a single-phase full-bridge circuit is provided with one filter 1 including the reactor 11, the filtering capacitor 12, and the switch 13.

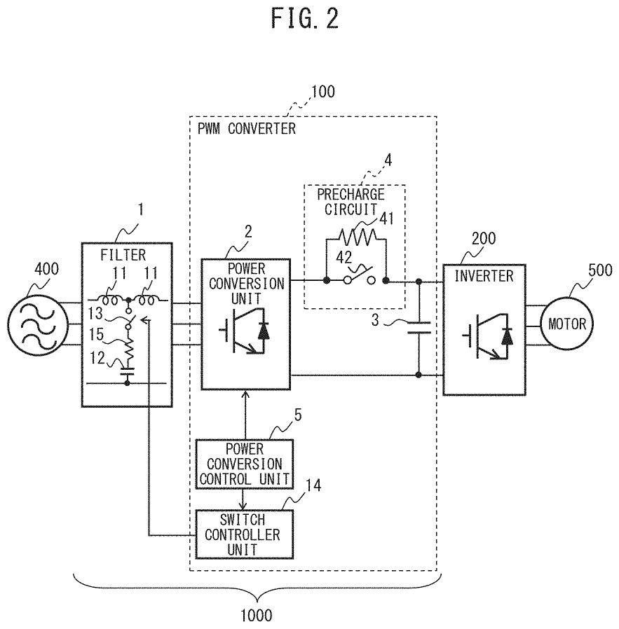

FIG. 2 is a diagram illustrating a filter and a converter system including a switch controller unit according to an embodiment of the present disclosure. FIG. 2 schematically illustrates the connection configuration of the reactor 11, the filtering capacitor 12, and the switch 13 in the filter 1. Although the switch controller unit 14 is provided in the filter 1 in the example illustrated in FIG. 1, the switch controller unit 14 may be provided in the PWM converter 100 instead as illustrated in FIG. 2. In this case, a converter system 1000 is constructed from: the PWM converter 100 that includes the power conversion unit 2, the smoothing capacitor 3, the precharge circuit 4, the power conversion control unit 5, and the switch controller unit 14; and the filter 1.

Next, four specific connection configurations of the reactor 11, the filtering capacitor 12, and the switch 13 in the filter 1 will be listed. In each of the first to fourth connection configuration, the reactor 11 is connected in series with the PWM converter 100, the filtering capacitor 12 is connected in parallel with the PWM converter 100, and the open/close operation of the switch 13 is controlled by the switch controller unit 14. The switch controller unit 14 is provided in the filter 1 as illustrated in FIG. 1 or in the PWM converter 100 as illustrated in FIG. 2.

In the examples illustrated in FIG. 1 and FIG. 2, since the AC power supply 400 is assumed to be a three-phase AC power supply, a three-phase power line electrically connects the AC power supply 400 with the power conversion unit 2 constructed from a three-phase full-bridge circuit. In each of the first to fourth connection configuration, each of the lines for two phases of the three-phase power line is provided with the filter 1 serving as the first filter, and the line for the remaining one phase is provided with the second filter (not illustrated) that is a filter constructed by removing the switch 13. In other words, the second filter includes a reactor to be connected in series with the PWM converter 100 and the filtering capacitor connected in parallel with the PWM converter 100, and the second filter is the same as a conventional filter in principle.

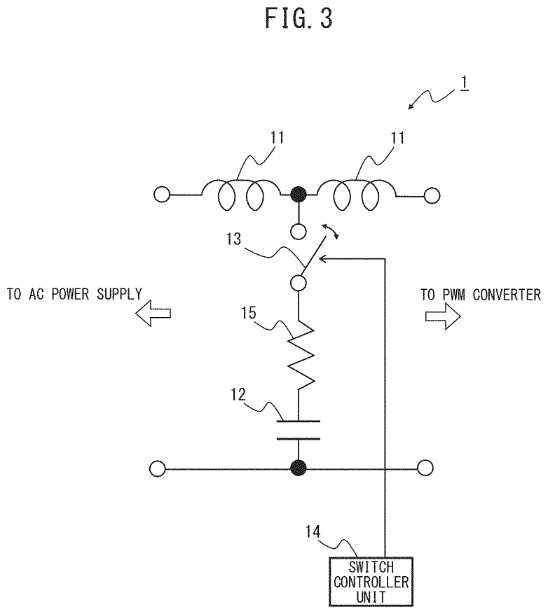

FIG. 3 is a diagram illustrating a first connection configuration of a filter according to an embodiment of the present disclosure. The filter 1 of the first connection configuration is configured as the first filter that includes two reactors 11, a filtering capacitor 12, a switch 13, and a resistor 15. In the filter 1 serving as the first filter, the two reactors 11 connected in series with each other are provided for each of the lines for two phases of the three-phase power line that connects the AC power supply 400 with the power conversion unit 2 of the PWM converter 100. One end of a set of the switch 13, the resistor 15, and the filtering capacitor 12 connected in series with each other is connected with the two reactors 11 provided for the lines for the two phases of the three-phase power line at a connecting point of the two reactors 11. At the same time, a filter is configured as the second filter (not illustrated) constructed by removing the switch 13 from the first filter as illustrated in FIG. 3. The line for the remaining one phase of the three-phase power line that connects the AC power supply 400 with the power conversion unit 2 of the PWM converter 100 is provided with the second filter that does not include the switch 13. In the second filter, two reactors are provided in the line for the remaining one phase of the three-phase power line that connects the AC power supply 400 with the power conversion unit 2 of the PWM converter 100, and one end of a set of a resistor and a filtering capacitor connected in series with each other is connected with the two reactors at a connecting point of the two reactors. One end of two first filters, the end not being connected to the aforementioned power line, and one end of one second filter, the end not being connected to the aforementioned power line are connected; consequently, the two first filters and the one second filter are connected in a star connection (Y connection). Note that, although the case where the filters are connected in a star connection (Y connection) has been described, one end of each filter, the end not being connected to the aforementioned power line may be connected at a point between the resistor 15 and the filtering capacitors 12 of another filter to form a delta connection (A connection). In addition, the sequence in the set of the switch 13, the resistor 15, and the filtering capacitor 12 in a series connection as illustrated in FIG. 3 is merely an example, and the series connection may be made in other sequences.

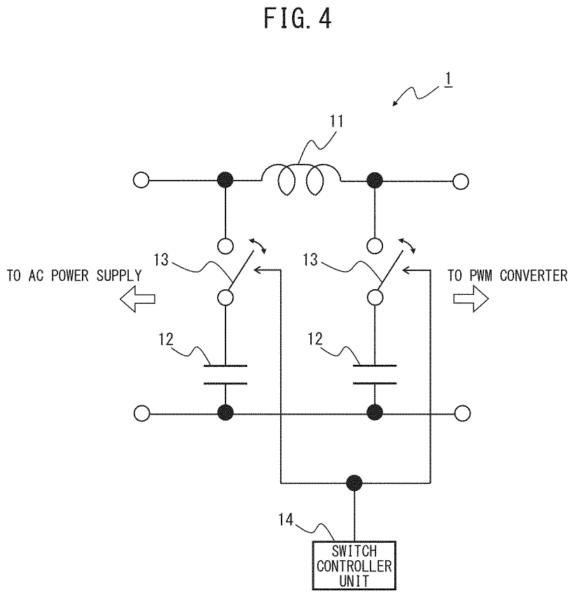

FIG. 4 is a diagram illustrating a second connection configuration of a filter according to an embodiment of the present disclosure. The filter 1 of the second connection configuration is configured as the first filter that includes a reactor 11, two filtering capacitors 12, and two switches 13. In the filter 1 serving as the first filter, the reactor 11 is provided for each of the lines for two phases of the three-phase power line that connects the AC power supply 400 with the power conversion unit 2 of the PWM converter 100. Two sets of the switch 13 and the filtering capacitor 12 connected in series with each other are connected with the reactor 11 provided for the lines for the two phases of the three-phase power line, one set at each end of the reactor 11. At the same time, a filter is configured as the second filter (not illustrated) constructed by removing the switch 13 from the first filter as illustrated in FIG. 4. The line for the remaining one phase of the three-phase power line that connects the AC power supply 400 with the power conversion unit 2 of the PWM converter 100 is provided with the second filter in which the switch 13 is removed. In the second filter, a reactor is provided in the line for the remaining one phase of the three-phase power line that connects the AC power supply 400 with the power conversion unit 2 of the PWM converter 100, and the filtering capacitors 12 are connected with the reactor 11 at both ends of the reactor 11. One end of two first filters, the end not being connected to the aforementioned power line, and one end of one second filter, the end not being connected to the aforementioned power line are connected; consequently, the two first filters and the one second filter are connected in a star connection (Y connection). Note that, although the case where the filters are connected in a star connection (Y connection) has been described, one end of each filter, the end not being connected to the aforementioned power line may be connected at a point between the switch 13 and the filtering capacitors 12 of another filter to form a delta connection (A connection). In addition, the sequence in the set of the switch 13 and the filtering capacitor 12 in a series connection as illustrated in FIG. 4 is merely an example, and the series connection may be made in other sequences.

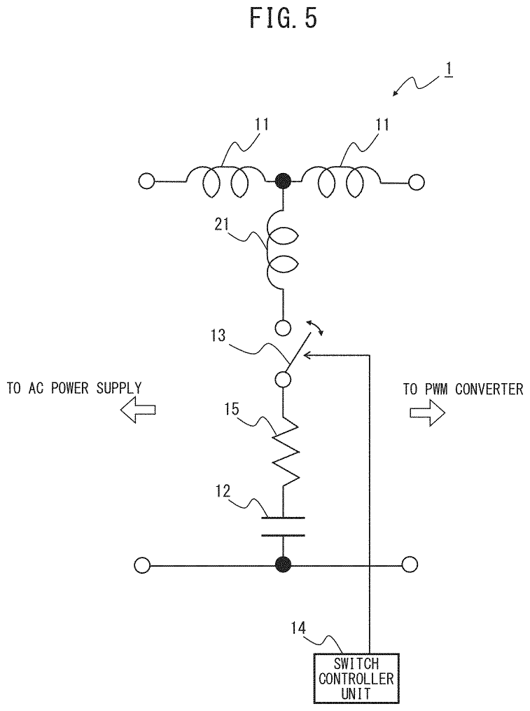

FIG. 5 is a diagram illustrating a third connection configuration of a filter according to an embodiment of the present disclosure. The filter 1 of the third connection configuration is configured as the first filter that includes two reactors 11, a filtering capacitor 12, a switch 13, a resistor 15, and a reactor 21. In the filter 1 serving as the first filter, the two reactors 11 connected in series with each other are provided for each of the lines for two phases of the three-phase power line that connects the AC power supply 400 with the power conversion unit 2 of the PWM converter 100. One end of a set of the reactor 21, the switch 13, the resistor 15, and the filtering capacitor 12 connected in series with each other is connected with the two reactors 11 provided for the lines for the two phases of the three-phase power line at a connecting point of the two reactors 11. At the same time, a filter is configured as the second filter (not illustrated) constructed by removing the switch 13 from the first filter as illustrated in FIG. 5. The line for the remaining one phase of the three-phase power line that connects the AC power supply 400 with the power conversion unit 2 of the PWM converter 100 is provided with the second filter in which the switch 13 is removed. In the second filter, two reactors are provided in the line for the remaining one phase of the three-phase power line that connects the AC power supply 400 with the power conversion unit 2 of the PWM converter 100, and one end of a set of a reactor (i.e., the one different from the two reactors for the line for the one phase of the power line), a resistor, and a filtering capacitor connected in series with each other is connected with the two reactors at a connecting point of the two reactors. One end of two first filters, the end not being connected to the aforementioned power line, and one end of one second filter, the end not being connected to the aforementioned power line are connected; consequently, the two first filters and the one second filter are connected in a star connection (Y connection). Note that, although the case where the filters are connected in a star connection (Y connection) has been described, one end of each filter, the end not being connected to the aforementioned power line may be connected at a point between the resistor 15 and the filtering capacitors 12 of another filter to form a delta connection (Δconnection). In addition, the sequence in the set of the reactor 21, the switch 13, the resistor 15, and the filtering capacitor 12 in a series connection as illustrated in FIG. 5 is merely an example, and the series connection may be made in other sequences.

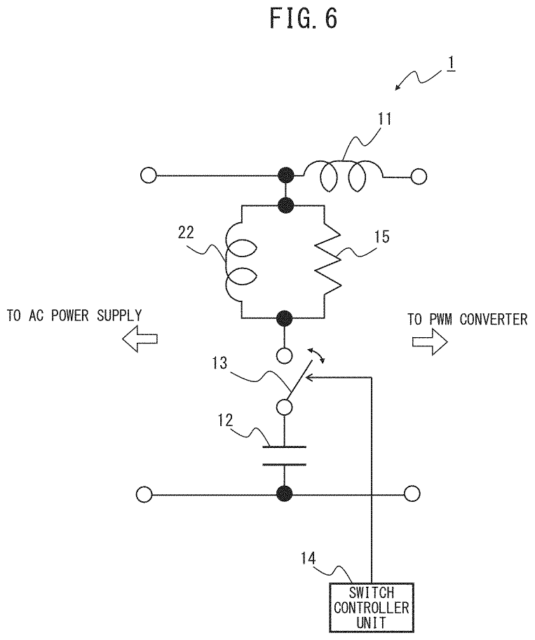

FIG. 6 is a diagram illustrating a fourth connection configuration of a filter according to an embodiment of the present disclosure. The filter 1 of the fourth connection configuration is configured as the first filter that includes a reactor 11, a filtering capacitor 12, a switch 13, a resistor 15, and a reactor 22. In the filter 1 serving as the first filter, the reactor 22 and the resistor 15 connected in parallel with each other, the switch 13, and the filtering capacitor 12 are connected in series with each other. The reactor 11 is provided for each of the lines for two phases of the three-phase power line that connects the AC power supply 400 with the power conversion unit 2 of the PWM converter 100. One end of a set of the reactor 22 and the resistor 15, the switch 13, and the filtering capacitor 12 is connected with the other end of the reactor 11 provided for the lines for the two phases of the three-phase power line, the end being opposite to the one end to which the PWM converter 100 is connected. At the same time, a filter is configured as the second filter (not illustrated) constructed by removing the switch 13 from the first filter as illustrated in FIG. 6. The line for the remaining one phase of the three-phase power line that connects the AC power supply 400 with the power conversion unit 2 of the PWM converter 100 is provided with the second filter in which the switch 13 is removed. In the second filter, a reactor is provided in the line for the remaining one phase of the three-phase power line that connects the AC power supply 400 with the power conversion unit 2 of the PWM converter 100, and one end of a set of a reactor (i.e., the one different from the two reactors for the line for the one phase of the power line), a resistor, and a filtering capacitor is connected with the other end of the reactor 11, the end being opposite to the one end to which the PWM converter 100 is connected. One end of two first filters, the end not being connected to the aforementioned power line, and one end of one second filter, the end not being connected to the aforementioned power line are connected; consequently, the two first filters and the one second filter are connected in a star connection (Y connection). Note that, although the case where the filters are connected in a star connection (Y connection) has been described, one end of each filter, the end not being connected to the aforementioned power line may be connected at a point between the switch 13 and the filtering capacitors 12 of another filter to form a delta connection (Δconnection). In addition, the sequence in the set of the reactor 22 and the resistor 15 connected in parallel with each other, the switch 13, and the filtering capacitor 12 in a series connection as illustrated in FIG. 6 is merely an example, and the series connection may be made in other sequences.

When the AC power supply 400 and the power conversion unit 2 are electrically connected by a three-phase power line in this way, in each of the first to fourth connection configuration described above, each of the lines for two phases of the three-phase power line is provided with the filter 1 serving as the first filter, and the line for the remaining one phase is provided with the second filter that is constructed by removing the switch 13 from the filter 1. Note that, when the AC power supply 400 and the power conversion unit 2 are electrically connected by a single-phase power line, there is provided with a single filter 1 in which one line for one phase of the power line is configured as the aforementioned first power line and the other line for the other phase of the power line is configured as the aforementioned second power line.

Next, several sequences of operations of the filter 1 and the switch 13 and the precharge circuit 4 in the PWM converter 100 according to an embodiment of the present disclosure will be described. The sequences of operations of the switch 13 and the precharge circuit 4 described below are applicable to any of the case where the switch controller unit 14 is provided in the filter 1 as illustrated in FIG. 1 and the case where the switch controller unit 14 is provided in the PWM converter 100 as illustrated in FIG. 2. In addition, the sequences of operations are applicable to any of the case where the precharge circuit 4 is provided between the power conversion unit 2 and the smoothing capacitor 3 and the case where the precharge circuit 4 is provided on the AC input/output side of the power conversion unit 2.

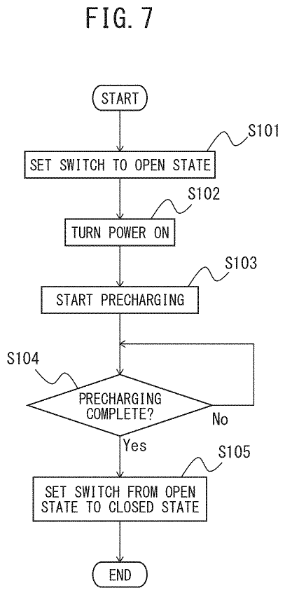

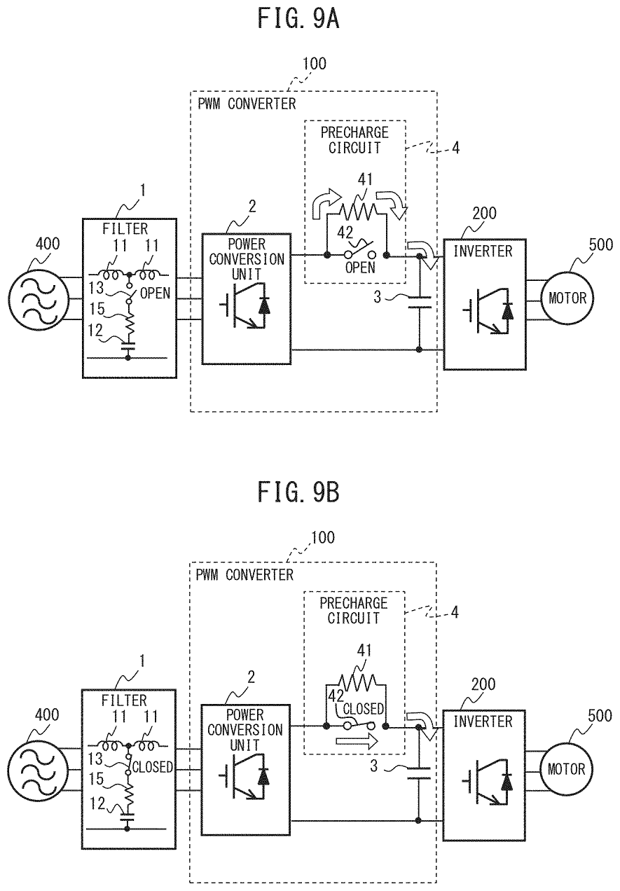

FIG. 7 is a flowchart illustrating a first operation mode of a filter, and a switch and a precharge circuit in a PWM converter according to an embodiment of the present disclosure. FIG. 9A is a diagram illustrating a flow of current in a sequence of operations of a filter, and a switch and a precharge circuit in a PWM converter according to an embodiment of the present disclosure, and illustrates the flow of current during a precharging period. FIG. 9B is a diagram illustrating a flow of current in a sequence of operations of a filter, and a switch and a precharge circuit in a PWM converter according to an embodiment of the present disclosure, and illustrates the flow of current after the precharging is complete.

Before the PWM converter 100 is powered on, the switch controller unit 14 controls the switch 13 in the filter 1 to be in the open state (step S101).

When the PWM converter 100 is powered on at step S102, the precharge circuit 4 starts precharging of the smoothing capacitor 3 at step S103. As illustrated in FIG. 9A, direct current output from the power conversion unit 2 will flow into the smoothing capacitor 3 through the precharge resistor 41 by setting the precharge switch 42 to the open state during the precharging period, which causes the smoothing capacitor 3 to be charged. During the precharging period, the direct current output from the power conversion unit 2 flows through the precharge resistor 41, and generation of inrush current can be prevented. It is noted that according to a conventional technique, LC resonance is caused by a filter at power-on of the PWM converter 100. By contrast, according to an embodiment of the present disclosure, in a period before the PWM converter 100 is powered on until the precharging is complete, the switch controller unit 14 continues to control the switch 13 in the filter 1 to be in the open state; consequently, no current flows through the filtering capacitor 12 in the filter 1. Therefore, after the power-on of the PWM converter 100 and through the precharging period, LC resonance will not be generated between the filtering capacitor 12 and the reactor 11 in the filter 1.

At step S104, the switch controller unit 14 determines whether the precharge circuit 4 has completed precharging of the smoothing capacitor 3 or not. When the smoothing capacitor 3 is charged to a predetermined voltage, the precharge circuit 4 switches the precharge switch 42 from the open state to the closed state to complete precharging, and a control unit configured to control the open/close operations of the precharge switch 42 (e.g., the power conversion control unit 5) notifies the switch controller unit 14 that precharging is complete. Note that, when the precharge switch 42 is switched from the open state to the closed state, the smoothing capacitor 3 and the power device in the power conversion unit 2 are connected in parallel with each other not through the precharge resistor 41, which causes fluctuation of voltage applied to the power device to be suppressed by the smoothing capacitor 3.

At step S104, when the switch controller unit 14 determines that the precharge circuit 4 has completed precharging of the smoothing capacitor 3, the switch controller unit 14 controls switching of the switch 13 in the filter 1 from the open state to the closed state at step S105. When the switch 13 in the filter 1 is switched to the closed state, LC resonance will be generated in the filter 1. After the precharging is complete, the precharge switch 42 in the closed state causes short circuit that enables connection without the precharge resistor 41 as illustrated in FIG. 9B; consequently, the smoothing capacitor 3 and the power device in the power conversion unit 2 are connected in parallel. The current generated by the LC resonance in the filter 1 will flow into the smoothing capacitor 3 via the power device, but since the capacitance of the smoothing capacitor 3 is significantly higher than that of the filtering capacitor 12, the voltage across the smoothing capacitor hardly fluctuates; thus, overvoltage due to the LC resonance will not be applied to the power device that is connected in parallel with the smoothing capacitor 3, and the power device will not be broken. In addition, since the switch 13 in the filter 1 is in the closed state, the filter 1 executes the inherent filtering function on the PWM converter 100. After step S105, the motor drive unit constructed from the filter 1, the PWM converter 100, and the inverter 200 can normally drive the motor 500 using the power supplied from the AC power supply 400.

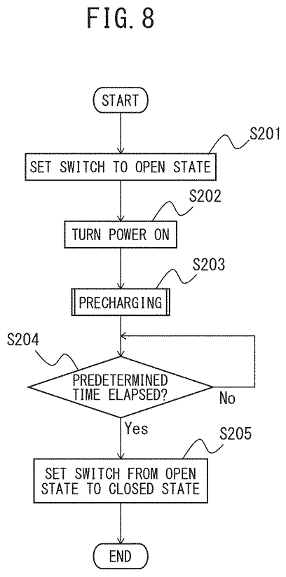

FIG. 8 is a flowchart illustrating a second operation mode of the filter, and the switch and the precharge circuit in the PWM converter according to an embodiment of the present disclosure.

Before the PWM converter 100 is powered on, the switch controller unit 14 controls the switch 13 in the filter 1 to be in the open state (step S201).

At step S202, the PWM converter 100 is powered on. In response to the power-on of the PWM converter 100, the switch controller unit 14 starts time keeping.

At step S203, the precharge circuit 4 starts precharging of the smoothing capacitor 3. In addition, as illustrated in FIG. 9A, direct current output from the power conversion unit 2 will flow into the smoothing capacitor 3 through the precharge resistor 41 by setting the precharge switch 42 to the open state during the precharging period, which causes the smoothing capacitor 3 to be charged. During the precharging period, the direct current output from the power conversion unit 2 flows through the precharge resistor 41, and generation of inrush current can be prevented. In addition, in a period before the PWM converter 100 is powered on until the precharging is complete, the switch controller unit 14 continues to control the switch 13 in the filter 1 to be in the open state; consequently, no current flows through the filtering capacitor 12 in the filter 1. Therefore, after the power-on of the PWM converter 100 and through the precharging period, LC resonance will not be generated between the filtering capacitor 12 and the reactor 11 in the filter 1.

At step S204, the switch controller unit 14 determines whether a predetermined time has passed or not since the PWM converter 100 was powered on. The aforementioned “predetermined time” used for the determination process by the switch controller unit 14 at step S204 is set to a time longer than that required for the precharge circuit 4 to complete precharging of the smoothing capacitor 3 since the power-on of the PWM converter 100. By setting the aforementioned “predetermined time” to such a time, it is possible to prevent the switch 13 from being switched from the open state to the closed state during the precharging period where the current from the power conversion unit 2 flows into the smoothing capacitor 3. Note that the time required for the precharge circuit 4 to complete precharging of the smoothing capacitor 3 since the power-on of the PWM converter 100 may be obtained, for example, from calculation based on the capacitance of the smoothing capacitor 3 or the combined capacitance of a plurality of capacitors provided in the DC link and the resistance of the precharge resistor 41 before shipment of the PWM converter 100 from the factory, or it may be obtained by measuring the time by actually activating the PWM converter 100 and the precharge circuit 4. The aforementioned “predetermined time” may be reconfigurable by an external device with the value stored on a rewritable storage unit (not illustrated); in this way, the aforementioned “predetermined time” may be changed to an appropriate value as appropriate even after it is already set.

The aforementioned “predetermined time” is thus set to a time longer than that required for the precharge circuit 4 to complete precharging of the smoothing capacitor 3 since the power-on of the PWM converter 100. Therefore, by the time the aforementioned “predetermined time” passes since the power-on of the PWM converter 100, the precharge circuit 4 will complete precharging by switching the precharge switch 42 from the open state to the closed state. When the precharge switch 42 is switched from the open state to the closed state in response to completion of the precharging, the smoothing capacitor 3 and the power device in the power conversion unit 2 are connected in parallel with each other not through the precharge resistor 41, which causes fluctuation of voltage applied to the power device to be suppressed by the smoothing capacitor 3.

At step S204, when the switch controller unit 14 determines that the predetermined time has passed, the switch controller unit 14 controls switching of the switch 13 in the filter 1 from the open state to the closed state at step S205. When the switch 13 in the filter 1 is switched to the closed state, LC resonance will be generated in the filter 1. After the precharging is complete, the precharge switch 42 in the closed state causes short circuit that enables connection without the precharge resistor 41 as illustrated in FIG. 9B; consequently, the smoothing capacitor 3 and the power device in the power conversion unit 2 are connected in parallel. The current generated by the LC resonance in the filter 1 will flow into the smoothing capacitor 3 via the power device, but since the capacitance of the smoothing capacitor 3 is significantly higher than that of the filtering capacitor 12, the voltage across the smoothing capacitor hardly fluctuates; thus, overvoltage due to the LC resonance will not be applied to the power device that is connected in parallel with the smoothing capacitor 3, and the power device will not be broken. In addition, since the switch 13 in the filter 1 is in the closed state, the filter 1 executes the inherent filtering function on the PWM converter 100. After step S205, the motor drive unit constructed from the filter 1, the PWM converter 100, and the inverter 200 can normally drive the motor 500 using the power supplied from the AC power supply 400.

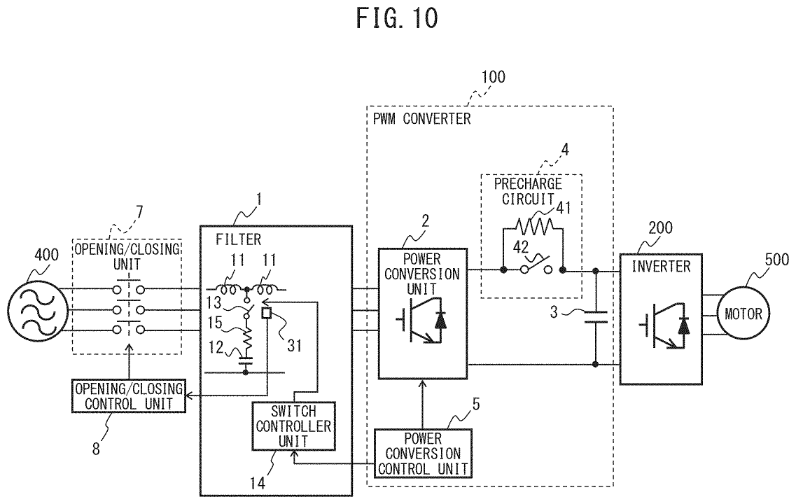

FIG. 10 is a diagram illustrating a filter including a switch controller unit and a converter system according to a variation of an embodiment of the present disclosure. In this variation, the switch 13 in the filter 1 is constructed from a so-called “force-guided relay”, which can detect a fault of an internal contact, and upon detection of a fault of the internal contact of the switch 13, the AC power supply 400 and the filter 1 are electrically disconnected. Note that although this variation is described assuming the case where the switch controller unit 14 is provided in the filter 1 as illustrated in FIG. 1, this variation is also applicable to the case where the switch controller unit 14 is provided in the PWM converter 100 as illustrated in FIG. 2. In addition, this variation is also applicable to any of the case where the precharge circuit 4 is provided between the power conversion unit 2 and the smoothing capacitor 3 and the case where the precharge circuit 4 is provided on the AC input/output side of the power conversion unit 2.

The filter 1 further includes a fault detection unit 31 configured to detect presence or absence of a fault of an internal contact of the switch 13. Examples of the switch 13 for which a fault of a contact may be detected by the fault detection unit 31 include a force-guided relay.

A force-guided relay has an NO (Normal Open) contact, which is normally open, and a NC (Normal Close) contact, which is normally closed. The NO contact and the NC contact are separated by a wall and insulated from each other. The NO contact and the NC contact are mechanically connected by a guide (link mechanism), and the NO contact and the NC contact work in conjunction with each other depending on presence or absence of voltage applied to an electromagnet of the relay. When voltage is not applied to the electromagnet of the relay, the NO contact is open while the NC contact is closed; when voltage is applied to the electromagnet of the relay, the NO contact is closed while the NC contact is open. When the NO contact is welded, even if voltage is not applied to the electromagnet of the relay, the NO contact will be in a closed state. In this case, the NC contact that works in conjunction with the NO contact by virtue of the guide will be kept in the open state although it should be in the closed state under normal conditions (i.e., when the NO contact is not welded). By detecting this condition, the fault detection unit 31 can detect that welding is generated at the contact (NO contact) of the switch 13.

On the AC power supply 400 side of the filter 1, there is provided an opening/closing unit 7 configured to selectively perform a connection operation in which the AC power supply 400 and the filter 1 are electrically connected and a disconnection operation in which the AC power supply 400 and the filter 1 are electrically disconnected by opening/closing an electric path between the AC power supply 400 and the filter 1. Examples of the opening/closing unit 7 include, for example, an electromagnetic contactor. The connection operation in which the AC power supply 400 and the filter 1 are electrically connected is performed by opening a contact of the electromagnetic contactor serving as the opening/closing unit 7 while the connection operation in which the AC power supply 400 and the filter 1 are electrically connected is performed by closing the contact of the electromagnetic contactor serving as the opening/closing unit 7. Instead of an electromagnetic contactor, a semiconductor switching device may be employed as the opening/closing unit 7. Examples of semiconductor switching devices include an IGBT, an FET, a thyristor, a GTO, and a transistor, although other types of semiconductor switching devices may be used.

Opening/closing of the electric path by the opening/closing unit 7 is controlled by an opening/closing control unit 8. When the fault detection unit 31 detects a fault of a contact of the switch 13, the opening/closing control unit 8 controls the opening/closing unit 7 to switch the electric path between the AC power supply 400 and the filter 1 from an open state to a closed state. In this way, the opening/closing unit 7 performs the disconnection operation in which the AC power supply 400 and the filter 1 are electrically disconnected. With this operation, even if the switch 13 in the filter 1 breaks down, flow of current from the AC power supply 400 into the PWM converter 100 can be blocked, and safety is ensured. Note that the opening/closing control unit 8 may be provided in the power conversion control unit 5.

The power conversion control unit 5, the switch controller unit 14, the opening/closing control unit 8, and the fault detection unit 31 described above may be constructed from an arithmetic processing device only, or may be constructed from a combination of an analog circuit and an arithmetic processing device, or may be constructed from an analog circuit only. The arithmetic processing devices that may constitute the power conversion control unit 5, the switch controller unit 14, the opening/closing control unit 8, and the fault detection unit 31 include an IC, an LSI, a CPU, an MPU, and a DSP. When the power conversion control unit 5, the switch controller unit 14, the opening/closing control unit 8, and the fault detection unit 31 are constructed, for example, in a software program form, functions of the power conversion control unit 5, the switch controller unit 14, the opening/closing control unit 8, and the fault detection unit 31 may be achieved by operating the arithmetic processing device in accordance with the software program. Alternatively, the power conversion control unit 5, the switch controller unit 14, the opening/closing control unit 8, and the fault detection unit 31 may be constructed as a semiconductor integrated circuit into which a software program for achieving the functions of the respective units is written. Alternatively, the power conversion control unit 5, the switch controller unit 14, the opening/closing control unit 8, and the fault detection unit 31 may be embodied as a recording medium onto which a software program for achieving the functions of the respective units is written. Alternatively, the power conversion control unit 5, the switch controller unit 14, the opening/closing control unit 8, and the fault detection unit 31 may be provided, for example, in a numerical control apparatus of a machine tool or in a robot controller that controls a robot.

### REFERENCE SIGNS LIST

1 filter
2 power conversion unit
3 smoothing capacitor
4 precharge circuit
5 power conversion control unit
7 opening/closing unit
8 opening/closing control unit
11 reactor
12 filtering capacitor
13 switch
14 switch controller unit
15 resistor
21 reactor
22 reactor
31 fault detection unit
41 precharge resistor
42 precharge switch
100 PWM converter
200 inverter
400 AC power supply
500 motor
1000 converter system

1. A filter provided on an AC input/output side of a PWM converter in which a smoothing capacitor and a precharge circuit configured to precharge the smoothing capacitor are connected, comprising:
a reactor to be connected in series with the PWM converter;
a filtering capacitor to be connected in parallel with the PWM converter; and
a switch configured to electrically connect the reactor with the filtering capacitor in a closed state and electrically disconnect the reactor from the filtering capacitor in an open state,
wherein the switch is in the open state when the PWM converter is powered on.

2. The filter according to claim 1, comprising a switch controller unit configured to control open/close operations of the switch.

3. The filter according to claim 2, wherein the switch controller unit controls switching of the switch from the open state to the closed state after the precharge circuit performs precharging of the smoothing capacitor upon power-on of the PWM converter and the precharging of the smoothing capacitor by the precharge circuit is complete.

4. The filter according to claim 2, wherein the switch controller unit controls switching of the switch from the open state to the closed state after a predetermined time has passed since the PWM converter was powered on.

5. The filter according to claim 1, wherein the filter serving as a first filter is provided for each line for two phases of a three-phase power line on the AC input/output side of the PWM converter that is constructed from a three-phase bridge circuit and a second filter including a second reactor to be connected in series with the PWM converter and a second filtering capacitor to be connected in parallel with the PWM converter is provided for the line for the remaining one phase.

6. The filter according to claim 1, wherein the switch is a relay.

7. The filter according to claim 1, further comprising: a fault detection unit configured to detect presence or absence of a fault of an internal contact of the switch,
wherein, when the fault detection unit detects a fault of a contact of the switch, an AC power supply and the filter are electrically disconnected.

8. A converter system, comprising:
a PWM converter including a power conversion unit configured to perform power conversion between AC power on the AC input/output side and DC power on the DC input/output side by means of a PWM control, a smoothing capacitor provided on the DC input/output side of the power conversion unit, and a precharge circuit configured to precharge the smoothing capacitor; and
a filter including a reactor to be connected in series with the power conversion unit on the AC input/output side, a filtering capacitor to be connected in parallel with the power conversion unit on the AC input/output side, and a switch configured to electrically connect the reactor with the filtering capacitor in a closed state and electrically disconnect the reactor from the filtering capacitor in an open state,
wherein the switch is in the open state when the PWM converter is powered on.

9. The converter system according to claim 8, wherein the PWM converter includes a switch controller unit configured to control open/close operations of the switch.

10. The converter system according to claim 9, wherein the switch controller unit controls switching of the switch from the open state to the closed state after the precharge circuit performs precharging of the smoothing capacitor upon power-on of the PWM converter and the precharging of the smoothing capacitor by the precharge circuit is complete.

11. The converter system according to claim 9, wherein the switch controller unit controls switching of the switch from the open state to the closed state after a predetermined time has passed since the PWM converter was powered on.

12. The converter system according to claim 8, wherein the filter serving as a first filter is provided for each line for two phases of a three-phase power line on the AC input/output side of the PWM converter that is constructed from a three-phase bridge circuit, and a second filter including a second reactor to be connected in series with the PWM converter and a second filtering capacitor to be connected in parallel with the PWM converter is provided for the line for the remaining one phase.

13. The converter system according to claim 8, wherein the switch is a relay.

14. The converter system according to claim 8,
wherein the filter includes a fault detection unit configured to detect presence or absence of a fault of an internal contact of the switch,
the converter system further comprising:
an opening/closing unit configured to selectively performs a connection operation in which an AC power supply and the filter are electrically connected and a disconnection operation in which the AC power supply and the filter are electrically disconnected; and
an opening/closing control unit configured to control the opening/closing unit to perform the disconnection operation when the fault detection unit detects a fault of the contact.
